(19) United States
(12) Patent Application Publication
(10) Pub. No.: US 2010/0225867 A1
(43) Pub. Date: Sep. 9, 2010

(54) TFT ARRAY SUBSTRATE AND TWISTED NEMATIC LIQUID CRYSTAL DISPLAY PANEL

(75) Inventors: Ling Chih Kao, Jhonghe City (TW); Hui Fang Cheng, Yongkang City (TW); Sung Chun Lin, Tainan City (TW); Kun Cheng Lee, Tainan County (TW); Chia Hua Yu, Banciao City (TW)

Correspondence Address: LOWE HAUPTMAN HAM & BERNER, LLP, 1700 DIAGONAL ROAD, SUITE 300, ALEXANDRIA, VA, 22314, US

(73) Assignee: HANNSTAR DISPLAY CORP., Taipei City (TW)

(21) Appl. No.: 12/623,319

(22) Filed: Nov. 20, 2009

(30) Foreign Application Priority Data
Mar. 4, 2009 (TW) 098106928

(51) Int. Cl. G02F 1/1343; G02F 1/13

(52) U.S. Cl. 349/139; 349/187

(57) ABSTRACT

A TFT array substrate includes a plurality of gate lines, common lines, data lines and pixel electrodes. Each common line includes a common electrode which is perpendicular to the gate line and has a first width. The data line has a second width and is perpendicular to the gate line, wherein two adjacent gate lines and two adjacent data lines define a pixel. The pixel electrodes are located in the pixels respectively, wherein the common electrode is overlapped with the data line and a part of the pixel electrode, and the common electrode completely shelters a gap between the pixel electrode and the data line.

### CROSS REFERENCE TO RELATED APPLICATION

This application claims the priority benefit of Taiwan Patent Application Serial Number 098106928, filed on Mar. 4, 2009, the full disclosure of which is incorporated herein by reference.

### TECHNICAL FIELD

The invention is related to a twisted nematic (TN) liquid crystal display panel, and more particularly to a TFT array substrate, wherein a common electrode is overlapped with a data line and a part of pixel electrode, and the common electrode completely shelters a gap between the pixel electrode and the data line.

### BACKGROUND

As high technology is developed gradually, a video product (e.g. digital video or image device) has become a popular product in the daily live. According to the digital video or image device, a liquid crystal display panel is an important component so as to display the correlative information. The user can read the necessary information from this liquid crystal display panel.

Referring to FIG. 1, a conventional twisted nematic (TN) liquid crystal display panel 10 includes a thin film transistor (TFT) array substrate 20, a color filter (CF) substrate 40 and a conventional twisted nematic (TN) liquid crystal layer 12. The TN liquid crystal layer 12 is located between the TFT array substrate 20 and the CF substrate 40. The TFT array substrate 20 includes a plurality of thin film transistors (TFTs) 21. Each TFT 21 includes a gate electrode 22, a gate insulating layer 24, an a-Si layer 25, a source electrode 26, a drain electrode 28, a passivating layer 30 (e.g. inorganic insulating layer) and a pixel electrode 32 which all are formed on a glass substrate 34 in sequence. The TFT array substrate 20 further includes a plurality of common electrodes 33a, wherein the overlap between the common electrode 33a and the pixel electrode 32 is formed to a storage capacitor.

The CF substrate 40 includes a black matrix 48, a color filter layer 42 and a transparent electrode 44 which all are formed on another glass substrate 46 in sequence. The black matrix 48 is adapted to shelter the lights which are leaked from the circumference of the pixel electrode 32.

Referring to FIGS. 2 and 3, a plurality of gate lines 52 and common electrodes 33a are disposed on the glass substrate 34. The common electrode 33a has a width W1. The gate insulating layer 24 covers the gate lines 52 and common electrodes 33a. A plurality of data lines 54 are disposed on the gate insulating layer 24, and the data line 54 has a width W2. Two adjacent gate lines 52 and two adjacent data lines 54 define a pixel 56. The common electrode 33a is located at one side of the pixel 56. The passivating layer 30 (e.g. inorganic insulating layer) covers the data lines 54. A plurality of pixel electrodes 32 are disposed on the passivating layer 30, and are located in the pixels 56 respectively.

Referring to FIG. 3 again, although the common electrodes 33a and data lines 54 can be adapted to shelter lights, the common electrodes 33a and data lines 54 are not overlapped with each other. In other words, there is a gap G between the common electrode 33a and data line 54, and the lights generated from a backlight source can be leaked from the gap G. Thus, the black matrix 48 is requested to have bigger width W3, thereby avoiding the lights leaked from the gap G. However, the black matrix 48 having bigger width W3 can increase the aperture ratio of the pixel 56.

Accordingly, there exists a need for a TFT array substrate capable of solving the above-mentioned problems.

### SUMMARY

The present invention provides a TFT array substrate including a plurality of gate lines, common lines, data lines and pixel electrodes. Each common line includes a common electrode which is perpendicular to the gate line and has a first width. The data line has a second width and is perpendicular to the gate line, wherein two adjacent gate lines and two adjacent data lines define a pixel. The pixel electrodes are located in the pixels respectively, wherein the common electrode is overlapped with the data line and a part of the pixel electrode, and the common electrode completely shelters a gap between the pixel electrode and the data line.

The common electrode of the present invention is overlapped with the data line and a part of the pixel electrode, and the common electrode completely shelters a gap between the pixel electrode and the data line. The common electrode is made of non-transparent material for effectively sheltering the lights which are leaked from the circumference of the data line and decreasing the influence of the fringe field on liquid crystal. Thus, the black matrix can only have smaller width to shelter the lights which are leaked from the circumference of the pixel electrode, whereby the pixels of the prevent invention has higher aperture ratio.

The foregoing, as well as additional objects, features and advantages of the invention will be more apparent from the following detailed description, which proceeds with reference to the accompanying drawings.

### BRIEF DESCRIPTION OF THE DRAWINGS

Embodiments of the present invention are illustrated by way of example, and not by limitation, in the figures of the accompanying drawings, wherein elements having the same reference numeral designations represent like elements throughout and wherein:

FIG. 1 is a cross-sectional schematic view of a twisted nematic (TN) liquid crystal display panel in the prior art;

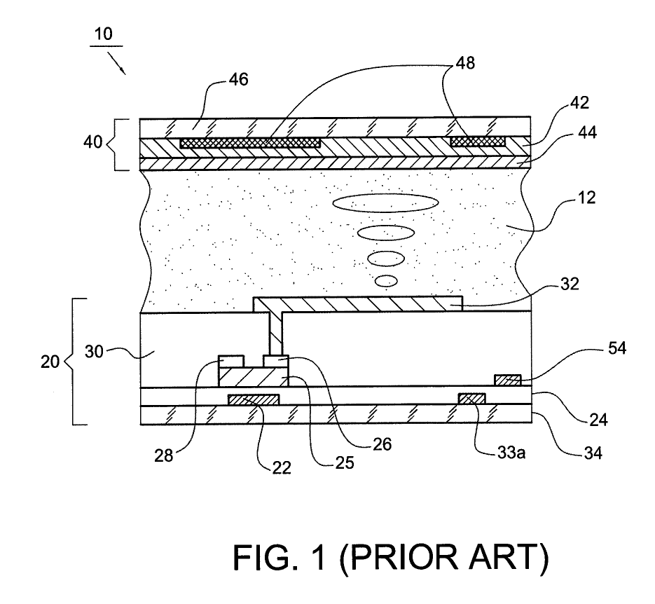

FIG. 2 is a plan schematic view of a TFT array substrate in the prior art;

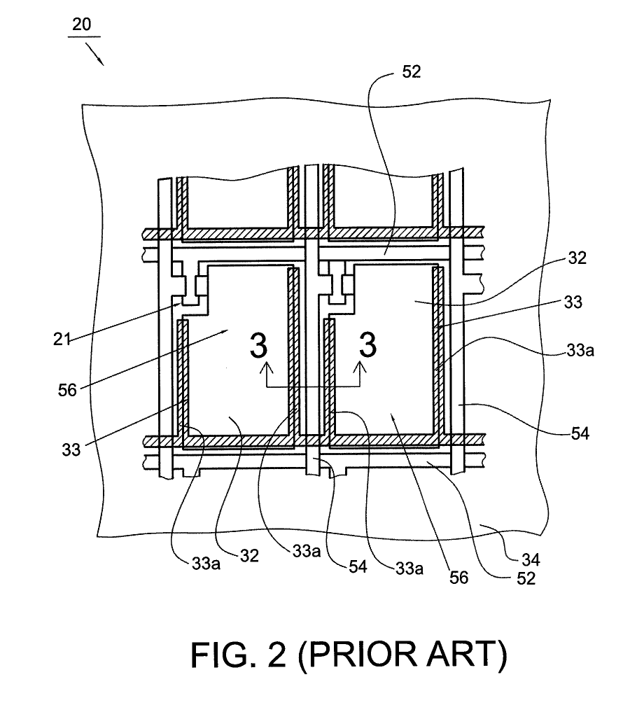

FIG. 3 is a partially cross-sectional view of the TFT array substrate along line 3-3 of FIG. 2;

FIG. 4 is a cross-sectional schematic view of a twisted nematic (TN) liquid crystal display panel according to an embodiment of the present invention;

FIG. 5 is a plan schematic view of a TFT array substrate according to an embodiment of the present invention; and

FIG. 6 is a partially cross-sectional view of the TFT array substrate along line 6-6 of FIG. 5.

### DETAILED DESCRIPTION OF THE PREFERRED EMBODIMENT

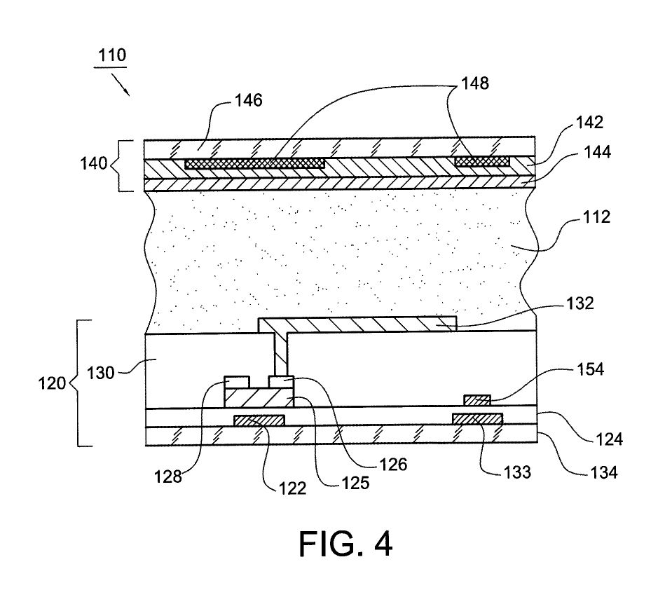

Referring to FIG. 4, it depicts a twisted nematic (TN) liquid crystal display panel 110 according to an embodiment of the present invention. The liquid crystal display panel 110 includes a thin film transistor (TFT) array substrate 120, a color filter (CF) substrate 140 and a conventional twisted nematic (TN) liquid crystal layer 112. The TFT array substrate 120 includes a plurality of thin film transistors (TFTs) 121, a gate insulating layer 124, a passivating layer 130 (e.g. inorganic insulating layer) and a plurality of pixel electrodes 132 which all are formed on a transparent substrate 134 (e.g. glass substrate) in sequence. The passivating layer 130 is adapted to protect the TFTs 121 and separates the pixel electrodes 132 from gate lines or data lines for decreasing the capacitance effect of the overlap between the pixel electrode 132 and gate line or data line. The TFT array substrate 120 further includes a plurality of common lines 133, wherein the overlap among the common lines 133, the gate insulating layer 124, the passivating layer 130 and a part of the pixel electrode 132 is formed to a storage capacitor. The CF substrate 140 includes a black matrix 148, a color filter layer 142 and a transparent electrode 144 which all are formed on another transparent substrate 146 in sequence. The black matrix 148 is adapted to shelter the lights which are leaked from the circumference of the pixel electrode 132.

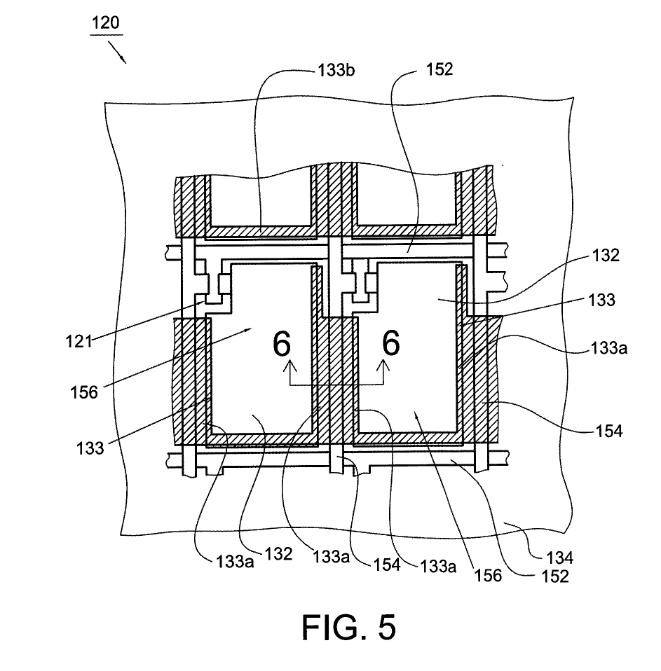

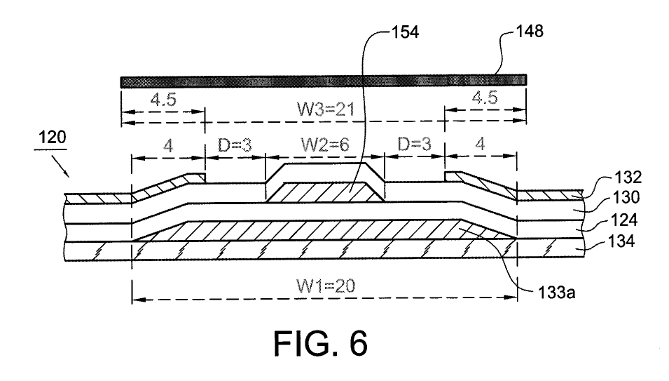

Referring to FIGS. 5 and 6, a plurality of gate lines 152 can be disposed on the transparent substrate 134 laterally, and the gate lines 152 and common lines 133 are located on the same level. The common lines 133 and gate lines 152 are made of same metallic material. Each common line 133 includes at least one common electrode 133a disposed on the transparent substrate 134 longitudinally, and the common electrode 133a has a first width W1. The common electrode 133a is perpendicular to the gate line 152. Each common line 133 includes another common electrode 133b which is disposed on the transparent substrate 134 laterally for connecting one common electrode 133a to another common electrode 133a. The gate insulating layer 124 is disposed on the transparent substrate 134 and covers the gate lines 152 and the common lines 133. A plurality of data lines 154 are disposed on the gate insulating layer 124 longitudinally, and each data line 154 has a second width W2. The data line 154 is perpendicular to the gate line 152. In order to avoid the signal interference (e.g. crosstalk) between the data line 154 and the common electrode 133a, the thickness value of the gate insulating layer 124 must be more than 2000 angstrom.

Two adjacent gate lines 152 and two adjacent data lines 154 define a pixel 156. Two common electrodes 133a which are disposed longitudinally are located at two sides of each pixel 156. The common electrode 133a is overlapped with the data line 154 and a part of the pixel electrode 132, and the common electrode 133a completely shelters a gap (i.e. lateral distance D) between the pixel electrode 132 and the data line 154, shown in FIG. 6. The common electrode 133a of the present invention is made of non-transparent material for effectively sheltering the lights which are leaked from the circumference of the data line 154 and decreasing the influence of the fringe field on liquid crystal. Thus, the black matrix 148 having smaller width W3 can be adapted to shelter the lights which are leaked from the circumference of the pixel electrode 132, whereby the pixels of the prevent invention has higher aperture ratio.

In this embodiment, the common electrode 133b which is disposed on the transparent substrate 134 laterally can be disposed at an edge of each pixel 156. In another embodiment, the common electrode 133b which is disposed on the transparent substrate 134 laterally can be also disposed at the intermediate location or other location of each pixel 156 if necessary. The passivating layer 130 is disposed on the gate insulating layer 124 and covers the data lines 154. The pixel electrodes 132 are disposed on the passivating layer 130, and located in the pixels 156 respectively. There is a lateral distance D between the pixel electrode 132 located in one pixel 156 and the data line 154, and also there is same lateral distance D between the pixel electrode 132 located in another adjacent pixel 156 and the data line 154.

Referring to FIG. 6 again, the width W1 of the common electrode 133a must be bigger than the sum of the width W2 of the data line 154 and 2 times the lateral distance D between the pixel electrode 132 and the data line 154, i.e. W1>W2+2D, whereby the overlap among the common electrode 133a, the gate insulating layer 124, the passivating layer 130 and a part of the pixel electrode 132 is formed to a storage capacitor.

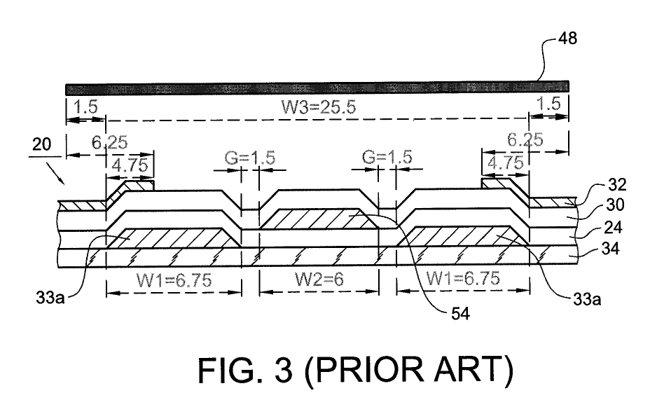

According to examples of the prior art and the prevention about pixels of 8-inch liquid crystal display panel, the correlative width and distance of the common electrode 33a, the data line 54 and the pixel electrode 32 of the pixels of 8-inch liquid crystal display panel in the prior art are shown in FIG. 3. For example, the width W1 of the common electrode 33a is 6.75 μm, and the width W2 of the data line 54 is 6 μm. However, the correlative width and distance of the common electrode 133a, the data line 154 and the pixel electrode 132 of the pixels of 8-inch liquid crystal display panel in the prevent invention are shown in FIG. 6. For example, the width W1 of the common electrode 133a is 20 μm, the width W2 of the data line 54 is 6 μm and the lateral distance D is 3 μm. Importantly, the width W3 of the black matrix 48 of the pixels of 8-inch liquid crystal display panel in the prior art must be 25.5 μm. The simulated aperture ratio of the pixel 56 which is electrical simulated by a liquid crystal simulating software 2DimMOS is 43.40%. Also, the real aperture ratio of the pixel 56 which is measured by an optical microscope (OM) is 38.99%. However, the width W3 of the black matrix 148 of the pixels of 8-inch liquid crystal display panel in the prevent invention can be 2 μm only. The simulated aperture ratio of the pixel 156 which is electrical simulated by a liquid crystal simulating software 2DimMOS is 47.78%. Also, the real aperture ratio of the pixel 156 which is measured by an optical microscope (OM) is 41.82%. Thus, the pixels of the prevent invention have higher aperture ratio certainly.

In addition, the present invention a method for manufacturing an array substrate including the following steps. A transparent substrate is provided. A plurality of gate lines are formed on the transparent substrate laterally. A plurality of common lines are formed on the transparent substrate, wherein each common line includes at least one first common electrode which is disposed on the transparent substrate longitudinally and has a first width. The gate lines and the common lines are formed by the same photolithography & etching processes simultaneously. A gate insulating layer is formed on the transparent substrate for covering the gate lines and the common lines. A plurality of data lines are formed on the gate insulating layer longitudinally, wherein each data line has a second width, and two adjacent gate lines and two adjacent data lines define a pixel. A passivating layer is formed on the gate insulating layer for covering the data lines. A plurality of pixel electrodes are formed on the passivating layer, wherein there is a lateral distance between the pixel electrode located in one pixel and the data line, and also there is same lateral distance between the pixel electrode located in another adjacent pixel and the data line. Furthermore, the first width must be bigger than the sum of the second width and 2 times the lateral distance.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An array substrate comprising:
a plurality of gate lines;
a plurality of common lines, each comprising at least one first common electrode, wherein the first common electrode is perpendicular to the gate line and has a first width;
a plurality of data lines, each having a second width and being perpendicular to the gate line, wherein two adjacent gate lines and two adjacent data lines define a pixel; and
a plurality of pixel electrodes located in the pixels respectively, wherein the first common electrode is overlapped with the data line and a part of the pixel electrode, and the first common electrode completely shelters a gap between the pixel electrode and the data line.

2. The array substrate as claimed in claim 1, further comprising:
a transparent substrate, wherein the gate lines are disposed on the transparent substrate laterally, and the first common electrodes are disposed on the transparent substrate longitudinally;
a gate insulating layer disposed on the transparent substrate and covering the gate lines and the common lines, wherein the data lines are disposed on the gate insulating layer longitudinally; and
a passivating layer disposed on the gate insulating layer and covering the data lines, wherein the pixel electrodes are disposed on the passivating layer.

3. The array substrate as claimed in claim 2, wherein the gap between the pixel electrode and the data line is a lateral distance, and the first width is bigger than the sum of the second width and 2 times the lateral distance.

4. The array substrate as claimed in claim 2, wherein the thickness value of the gate insulating layer is more than 2000 angstrom.

5. The array substrate as claimed in claim 2, wherein each common line comprises at least one second common electrode disposed on the transparent substrate laterally for connecting one first common electrode to another first common electrode.

6. The array substrate as claimed in claim 2, wherein the overlap among the first common electrode, the gate insulating layer, the passivating layer and a part of the pixel electrode is formed to a storage capacitor.

7. The array substrate as claimed in claim 6, wherein the first common electrode is made of non-transparent material.

8. The array substrate as claimed in claim 7, wherein the non-transparent material is metal.

9. The array substrate as claimed in claim 1, wherein the common lines and gate lines are located on the same level.

10. The array substrate as claimed in claim 9, wherein the common lines and gate lines are made of same metallic material.

11. A method for manufacturing an array substrate comprising the following steps of:
providing a transparent substrate;
forming a plurality of gate lines on the transparent substrate laterally;
forming a plurality of common lines on the transparent substrate, wherein each common line comprises at least one first common electrode which is disposed on the transparent substrate longitudinally and has a first width;
forming a gate insulating layer on the transparent substrate for covering the gate lines and the common lines;
forming a plurality of data lines on the gate insulating layer longitudinally, wherein each data line has a second width, and two adjacent gate lines and two adjacent data lines define a pixel;
forming a passivating layer on the gate insulating layer for covering the data lines; and
forming a plurality of pixel electrodes on the passivating layer, wherein the pixel electrodes are located in the pixels respectively, the first common electrode is overlapped with the data line and a part of the pixel electrode, the first common electrode completely shelters a gap (i.e. lateral distance) between the pixel electrode and the data line, and the first width is bigger than the sum of the second width and 2 times the lateral distance.

12. The method as claimed in claim 11, wherein the gate lines and the common lines are formed by the same photolithography & etching processes simultaneously.

13. A twisted nematic liquid crystal display panel comprising:
an array substrate comprising:
a plurality of gate lines;
a plurality of common lines, each comprising at least one first common electrode, wherein the first common electrode is perpendicular to the gate line and has a first width;
a plurality of data lines, each having a second width and being perpendicular to the gate line, wherein two adjacent gate lines and two adjacent data lines define a pixel; and
a plurality of pixel electrodes located in the pixels respectively, wherein the first common electrode is overlapped with the data line and a part of the pixel electrode, and the first common electrode completely shelters a gap between the pixel electrode and the data line; and
a color filter substrate comprising a plurality of black matrixes adapted to shelter the lights which are leaked from the circumference of the pixel electrode:

14. The twisted nematic liquid crystal display panel as claimed in claim 13, wherein the array substrate further comprises:
a transparent substrate, wherein the gate lines are disposed on the transparent substrate laterally, and the first common electrodes are disposed on the transparent substrate longitudinally;
a gate insulating layer disposed on the transparent substrate and covering the gate lines and the common lines, wherein the data lines are disposed on the gate insulating layer longitudinally; and
a passivating layer disposed on the gate insulating layer and covering the data lines, wherein the pixel electrodes are disposed on the passivating layer.

15. The twisted nematic liquid crystal display panel as claimed in claim 14, wherein the gap between the pixel electrode and the data line is a lateral distance, and the first width is bigger than the sum of the second width and 2 times the lateral distance.

16. The twisted nematic liquid crystal display panel as claimed in claim 14, wherein the overlap among the first common electrode, the gate insulating layer, the passivating layer and a part of the pixel electrode is formed to a storage capacitor.

17. The twisted nematic liquid crystal display panel as claimed in claim 14, wherein the first common electrode is made of non-transparent material.

18. The twisted nematic liquid crystal display panel as claimed in claim 17, wherein the non-transparent material is metal.

19. The twisted nematic liquid crystal display panel as claimed in claim 14, wherein the common lines and gate lines are located on the same level.

20. The twisted nematic liquid crystal display panel as claimed in claim 19, wherein the common lines and gate lines are made of same metallic material.
